(19) United States
(12) Patent Application Publication
(10) Pub. No.: US 2017/0130939 A1
(43) Pub. Date: May 11, 2017

(54) FLOOD LIGHT STRUCTURE

(71) Applicant: iGLO, LLC, Grapevine, TX (US)

(72) Inventor: Sonny Menon, Grapevine, TX (US)

(21) Appl. No.: 14/937,659

(22) Filed: Nov. 10, 2015

(51) Int. Cl. F21V 19/00; F21V 7/04; F21V 29/89; F21V 23/02; F21S 8/00; F21V 29/70

(52) U.S. Cl. CPC F21V 19/0025; F21S 8/003; F21V 29/70; F21V 29/89; F21V 23/02; F21V 7/04; F21W 2131/10

(57) ABSTRACT

The present disclosure provides a flood light structure for one or more flood lights. The flood light structure includes an assembly of a physical supporting base positioned in the flood light structure. The assembly is constructed with a plurality of substances. In addition, the flood light structure includes an insulation layer. The insulation layer is longitudinally disposed over a surface of each of one or more printed circuit board. Moreover, the flood light structure includes one or more light emission element securely mounted on surface of each of the one or more printed circuit board through the insulation layer. Further, the physical supporting base includes one or more printed circuit board. Each of the one or more printed circuit board has a metal core. Also, a thermal conductivity associated with each of the one or more printed circuit board is in a range of 0.5-3 W/Mk.

### TECHNICAL FIELD

The present disclosure relates to the field of flood light structures. More specifically, the present disclosure relates to utilization of light emitting diodes in the flood light structure.

### BACKGROUND

In an emerging era of rapid development in electronic technology, advancement in product design, appearance, and more obvious sophisticated electronic components used in the products is observed. A continuous development is recognized in field of light emitting diodes (hereinafter ‘LED’) too. Generally, these features are reflected in packing density of the LEDs to have enhanced seismic capability, high reliability, and improved production efficiency.

Nowadays, the LEDs are mounted on a Printed Circuit Board (hereinafter ‘PCB’) substrate. These designs provide a comparable superiority over previously designed LEDs. The LEDs which are mounted on the PCB substrate try to meet high precision, high efficiency and high reliability requirements. Further, it is easy to implement automation in these structures. Moreover, an emerging trend of development of these assemblies results in saving of energy and longer life time. This is due to its increased efficiency. Moreover, these LED assemblies possess environmental benefits too. Due to these benefits, the structures having the LEDs mounted on the PCB substrate is in a great demand today and finds many applications. Various applications of such structures include but may not be limited to lighting of fields during low lighting conditions and lighting during live performances on stage shows. Also, various applications of such structures include lighting on bridges, under tunnels, buildings, showrooms, street lighting and the like.

However, present LED housings increases lumen maintenance and durability of the LEDs only up to an extent. The present housings fail to provide considerable lumen maintenance on further increasing the packing density of the LEDs. Further, the present LED housings increases junction temperature of the LEDs on increasing the packing density of the LEDs. The junction temperature is highest operating temperature of a semiconductor in an electronic device. More particularly, the junction temperature of LEDs is its highest operating temperature in the LED housing. The increased junction temperature drastically affects the lumen maintenance of the LEDs. For example, if a new LED housing has a considerable junction temperature (say, in a range of 75-80 degree Celsius) and sufficient lumen maintenance, its lumen maintenance is expected to decrease in future. In addition, the present LED housings tend to reduce its thermal management capabilities over a period of time.

In light of the above stated discussion, there is a need for a flood light structure that could overcome the above stated disadvantages. Further, the flood light structure should possess significant lumen maintenance even on increasing the packing density of the LEDs in the LED housing. Furthermore, the flood light structure should possess a longer durability of the LEDs. In addition, the flood light structure should come up with a more compact design. Moreover, the flood light structure should reduce the junction temperature of the LEDs even on increasing the compactness and the packing density of the LEDS.

### SUMMARY

In an aspect of the present disclosure, the present disclosure provides a flood light structure for one or more flood lights. The flood light structure is powder coated. The flood light structure includes an assembly of a physical supporting base positioned in the flood light structure. The assembly is constructed with a plurality of substances. In addition, the flood light structure includes an insulation layer. The insulation layer is longitudinally disposed over a surface of each of one or more printed circuit board. Moreover, the flood light structure includes one or more light emission element securely mounted on surface of each of the one or more printed circuit board through the insulation layer. Further, the physical supporting base includes one or more printed circuit board. Each of the one or more printed circuit board has a metal core. The one or more printed circuit board is mounted parallel to each other. Also, a thermal conductivity associated with each of the one or more printed circuit board is in a range of 0.5-3 W/Mk. The insulation layer provides protection to each of the one or more printed circuit board. Furthermore, a thermal conductivity of the insulation layer is in a range of 0.5-9 W/Mk. The insulation layer is a ceramic non-conductive layer. Each of the one or more light emission arrangements includes a plurality of light emitting diodes. In addition, each of the one or more light emission arrangements is configured to emit light in a uniform direction substantially parallel to the one or more printed circuit board. The plurality of light emitting diodes is connected to the corresponding one or more printed circuit board through a plurality of holes. Also, each of the plurality of light emitting diodes has density in a range of 2.17-2.2 pieces per square centimeters. Each of the plurality of light emitting diodes possesses a thermal resistance in a pre-determined range of 4.0-6.0 m²K/W. Moreover, increased lumen maintenance of the plurality of light emitting diodes is achieved by optimization of a junction temperature associated with the plurality of light emitting diodes. The junction temperature is optimized in a pre-determined range of 65-70 degree Celsius.

In an embodiment of the present disclosure, a printed circuit board of the one or more printed circuit board is internally linked to another printed circuit board of the one or more printed circuit board in the flood light structure.

In an embodiment of the present disclosure, the printed circuit board of the one or more printed circuit board operates separately from the another printed circuit board of the one or more printed circuit board in the flood light structure. The flood light structure possesses a correlated color temperature of 5000 Kelvin.

In an embodiment of the present disclosure, the flood light structure further includes one or more power supplying devices attached to the flood light structure through the one or more printed circuit board. The one or more power supplying devices is configured for powering up the one or more light emission arrangements by supplying an aggregate power of 400-450 W. Each of the one or more printed circuit board receives equal amount of power.

In an embodiment of the present disclosure, the plurality of substances for the construction of the one or more printed circuit board includes at least one of an aluminium substrate, one or more tinned copper tracks and white mask.

In an embodiment of the present disclosure, each of the one or more light emission arrangements includes a first pre-defined amount of sequential arrangements of the plurality of light emitting diodes. In addition, each of the one or more light emission arrangements includes a second pre-defined amount of lateral arrangements of the plurality of light emitting diodes. Further, the first pre-defined amount is sixteen. Furthermore, the second pre-determined amount is seven. The plurality of light emitting diodes possesses a correlated color temperature of 5000 Kelvin.

In an embodiment of the present disclosure, the insulation layer is greased with a thermal paste to transfer dissipated heat to a heat sink.

In an embodiment of the present disclosure, each of the plurality of light emitting diodes is arranged longitudinally on each of the one or more printed circuit board.

In another aspect of the present disclosure, the present disclosure provides a flood light structure for one or more flood lights. The flood light structure is powder coated. The flood light structure includes an assembly of a physical supporting base positioned optimally in the flood light structure. In addition, the flood light structure includes an insulation layer. The insulation layer is placed in a longitudinal direction over a length on each of the one or more printed circuit board. Further, the flood light structure includes one or more light emitting sources connected to the corresponding one or more printed circuit board through the plurality of holes. Furthermore, the flood light housing includes one or more power supplying sources. The one or more power supplying sources is electrically coupled to each of the one or more light emitting sources. The one or more power supplying sources supply an aggregate power of 400-450 W to power up the one or more light emitting sources. In addition, the physical supporting base includes one or more printed circuit board. Each of the one or more printed circuit board has a metal core. The one or more printed circuit board is mounted parallel to each other. Also, a thermal conductivity associated with each of the one or more printed circuit board is in a range of 0.5-3 W/Mk. Further, each of the one or more printed circuit board includes a fixing arrangement. The fixing arrangement includes a plurality of holes. The plurality of holes is fixed on each of the one or more printed circuit board. Also, each of the plurality of holes is placed along a boundary of the flood light structure and corners of the one or more printed circuit board. In addition, the fixing arrangement includes a metallic substrate wired with one or more tinned copper tracks. The metallic substrate is made of aluminium. Moreover, the insulation layer provides protection to each of the one or more printed circuit board. Also, a thermal conductivity of the insulation layer is in a range of 0.5-9 W/Mk. The insulation layer is a ceramic non-conductive layer. Further, each of the one or more light emitting sources includes a plurality of light emitting diodes. Each of the one or more light emitting sources is longitudinally placed apart from each other. Also, each of the one or more light emitting diodes is bonded with the metallic substrate via the insulation layer. Each of the plurality of light emitting diodes has density in a range of 2.17-2.2 pieces per square centimeters. Further, each of the plurality of light emitting diodes possesses a thermal resistance in a pre-determined range of 4.0-6.0 m²K/W. In addition, each of the one or more light emitting sources receives an equal amount of power. Also, increased lumen maintenance of the plurality of light emitting diodes is achieved by optimization of a junction temperature associated with the plurality of light emitting diodes. The optimized junction temperature is in a range of 65-70 degree Celsius.

In an embodiment of the present disclosure, each of the one or more light emitting sources includes a first pre-defined amount of sequential arrangements of the plurality of light emitting diodes. In addition, each of the one or more light emitting sources includes a second pre-defined amount of lateral arrangements of the plurality of light emitting diodes. Further, the first pre-defined amount is sixteen. Furthermore, the second pre-determined amount is seven. The plurality of light emitting diodes possesses a correlated color temperature of 5000 Kelvin.

In an embodiment of the present disclosure, the insulation layer is greased with a thermal paste to transfer dissipated heat to a heat sink.

In an embodiment of the present disclosure, each of the plurality of light emitting diodes protrudes in a vertical direction on each of the one or more printed circuit board.

In an embodiment of the present disclosure, a printed circuit board of the one or more printed circuit board is internally linked to another printed circuit board of the one or more printed circuit board in the flood light structure.

In an embodiment of the present disclosure, the printed circuit board of the one or more printed circuit board operates separately from the another printed circuit board of the one or more printed circuit board in the flood light structure. The flood light structure possesses a correlated color temperature of 5000 Kelvin.

In yet another aspect of the present disclosure, the present disclosure provides a flood light structure for one or more flood lights. The flood light structure is powder coated. The flood light structure includes an assembly of a physical supporting base being positioned optimally in the flood light structure. In addition, the flood light structure includes an insulation layer. The insulation layer is longitudinally placed over a length on each of one or more printed circuit board. Further, the flood light structure includes one or more light emitting apparatus connected to the corresponding one or more printed circuit board through the plurality of holes. Furthermore, the flood light structure includes a transparent cover. In addition, the flood light structure includes one or more power feeding arrangements configured to supply an aggregate power of 400-450 W to light up the one or more light emitting apparatus. Moreover, the physical supporting base includes the one or more printed circuit board. Each of the one or more printed circuit board has a metal core. The one or more printed circuit board is mounted parallel to each other. Also, a thermal conductivity associated with each of the one or more printed circuit board is in a range of 0.5-3 W/Mk. In addition, each of the one or more printed circuit board includes a fixing arrangement. The fixing arrangement includes a plurality of holes. The plurality of holes is fixed on each of the one or more printed circuit board. Also, each of the plurality of holes is placed along a boundary of the flood light structure. Further, the fixing arrangement includes a metallic substrate wired with one or more tinned copper tracks. The metallic substrate is made of aluminium. Moreover, the insulation layer provides protection to each of the one or more printed circuit board. Also, a thermal conductivity of the insulation layer is in a range of 0.5-9 W/Mk. The insulation layer is a ceramic non-conductive layer. In addition, each of the one or more light emitting apparatus includes the plurality of light emitting diodes. Each of the one or more light emitting apparatus is longitudinally placed apart from each other. Also, each of the one or more light emitting diodes is bonded with the metallic substrate via the insulation layer. Moreover, each of the plurality of light emitting diodes has density in a range of 2.17-2.2 pieces per square centimeters. Each of the plurality of light emitting diodes possesses a thermal resistance in a pre-determined range of 4.0-6.0 m²K/W. Furthermore, the transparent cover encloses the flood light structure. In addition, a plurality of illuminating heads of each of the plurality of light emitting diodes face towards the transparent cover in a vertical direction. Each of the one or more light emitting apparatus receives an equal amount of power. Further, increased lumen maintenance of the plurality of light emitting diodes is achieved by optimization of a junction temperature associated with the plurality of light emitting diodes. The optimized junction temperature is in a range of 65-70 degree Celsius.

In an embodiment of the present disclosure, each of the one or more light emitting apparatus includes a first pre-defined amount of sequential arrangements of the plurality of light emitting diodes. In addition, each of the one or more light emitting apparatus includes a second pre-defined amount of lateral arrangements of the plurality of light emitting diodes. Further, the first pre-defined amount is sixteen. Furthermore, the second pre-determined amount is seven. The plurality of light emitting diodes possesses a correlated color temperature of 5000 Kelvin.

In an embodiment of the present disclosure, the insulation layer is greased with a thermal paste to transfer dissipated heat to a heat sink.

In an embodiment of the present disclosure, each of the plurality of light emitting diodes protrudes in a vertical direction on each of the one or more printed circuit board. The flood light structure possesses a correlated color temperature of 5000 Kelvin.

In an embodiment of the present disclosure, the transparent cover is made of aluminium di-casting alloys.

In an embodiment of the present disclosure, the flood light housing further includes one or more reflectors disposed on the one or more printed circuit board. Each of the one or more reflectors is configured to reflect light emitting from each of the plurality of light emitting diodes. In addition, the one or more reflectors include a top reflector and a bottom reflector.

### BRIEF DESCRIPTION OF THE FIGURES

Having thus described the invention in general terms, reference will now be made to the accompanying drawings, which are not necessarily drawn to scale, and wherein:

FIG. 1A illustrates a flood light structure, in accordance with various embodiments of the present disclosure;

FIG. 1B illustrates an inner view of the flood light structure, in accordance with various embodiments of the present disclosure;

FIG. 2 illustrates a metal core printed circuit board, in accordance with various embodiments of the present disclosure;

FIG. 3 illustrates a structural element of the flood light structure, in accordance with various embodiments of the present disclosure;

FIG. 4 illustrates a reflector, in accordance with various embodiments of the present disclosure;

FIG. 5A illustrates a first clamp, in accordance with various embodiments of the present disclosure;

FIG. 5B illustrates a second clamp, in accordance with various embodiments of the present disclosure;

FIG. 6A illustrates a third clamp, in accordance with various embodiments of the present disclosure;

FIG. 6B illustrates a fourth clamp, in accordance with various embodiments of the present disclosure; and

FIG. 7 illustrates a holding bracket, in accordance with various embodiments of the present disclosure.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

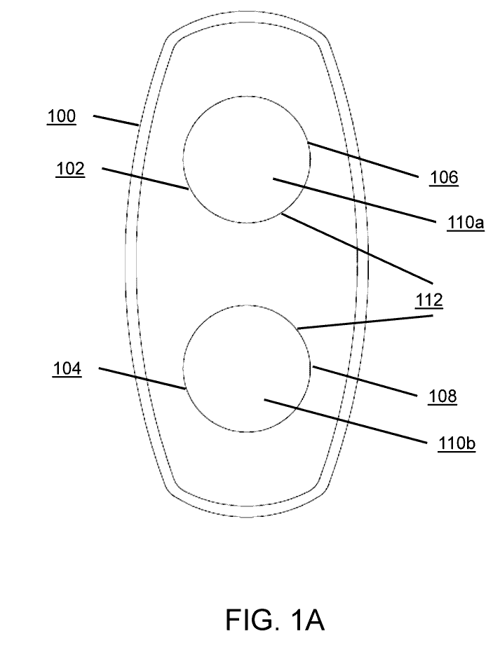

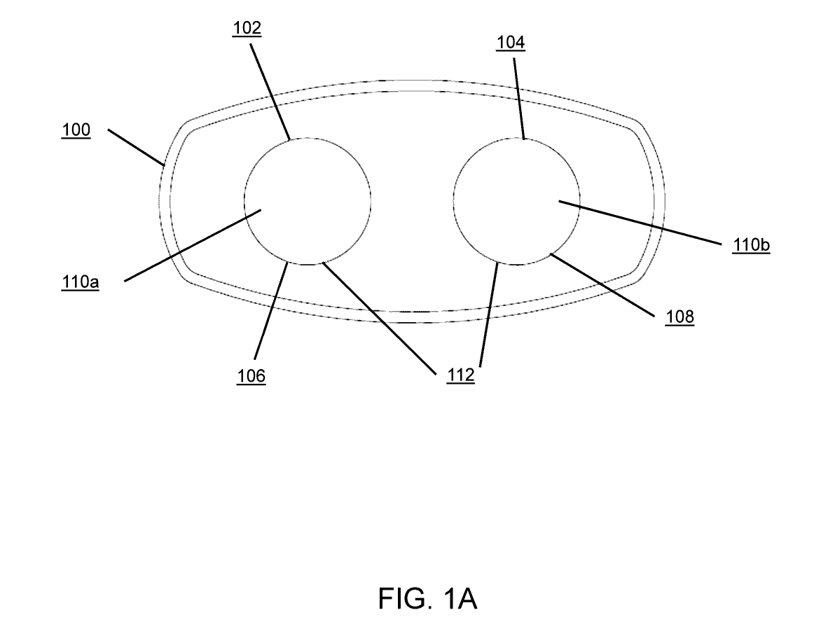

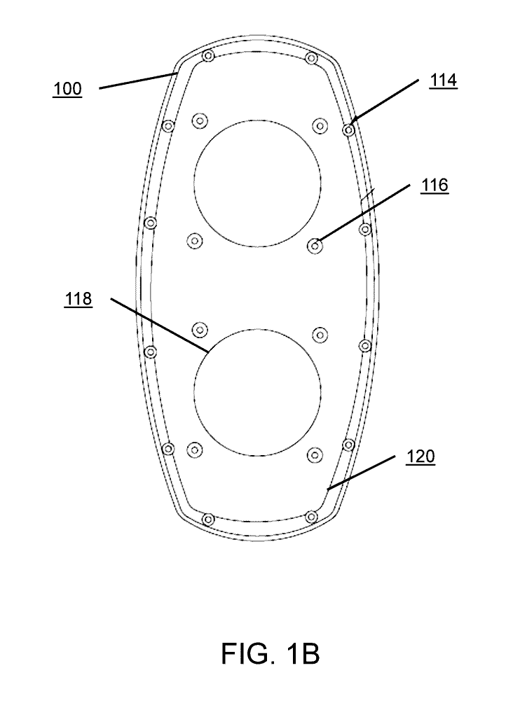

FIG. 1A illustrates a flood light structure 100 for one or more flood lights, in accordance with various embodiments of the present disclosure. The flood light structure is powder coated. Moreover, the flood light structure 100 is a casing and/or an enclosure for one or more flood lights. The one or more flood lights are broad-beamed and high-intensity artificial lights. In addition, the one or more flood lights illuminate outdoor playing fields when an outdoor sports event is being held during low-light conditions and stages during live performances. The live performances include concerts, plays and the like.

In addition, the flood light structure 100 includes an assembly of a physical supporting base. The assembly is positioned in the flood light structure 100. Also, the assembly is constructed with a plurality of substances. The plurality of substances includes an aluminium substrate, one or more tinned copper tracks and white mask. Moreover, the physical supporting base includes a printed circuit board 102 and printed circuit board 104. Further, the printed circuit board 102 and the printed circuit board 104 have a metal core. Also, the printed circuit board 102 and the printed circuit board 104 are mounted parallel to each other.

The printed circuit board 102-104 mechanically supports and electrically connects various electronic components by utilizing conductive tracks, pads and other features which are laminated onto a non-conductive substrate. The flood light structure 100 is made of aluminium di-casting (hereinafter ‘ADC’) alloys. In an embodiment of the present disclosure, the flood light structure 100 is made of ADC 12.

The printed circuit board 102-104 is a metallic board that can bear large mechanical loads, high temperature, high level of dimensional stability and the like. In an embodiment of the present disclosure, the printed circuit board 102-104 is a tecrona coated metal core board (metal core TC-2). The metal core printed circuit board 102-104 posses an increased thermal conductivity up to 3 W/Mk. The thermal conductivity is a property of the printed circuit board 102-104 to conduct heat.

Going further, the printed circuit board 102 includes a light emission arrangement 106 and the printed circuit board 104 includes a light emission arrangement 108. The light emission arrangement 106-108 is securely mounted on surface of each of the printed circuit board 102-104. Also, the light emission arrangement 106-108 is configured to emit light in a uniform direction substantially parallel to the printed circuit board 102-104. Further, the light emission arrangement 106 includes a plurality of light emitting diodes 110a and the light emission arrangement 108 includes a plurality of light emitting diodes 110b.

The plurality of light emitting diodes 110a-b is connected to the corresponding printed circuit board 102-104 through a plurality of holes. Furthermore, the plurality of light emitting diodes 110a-b possesses a density in a range of 2.17-2.2 pieces per square centimeters. The plurality of light emitting diodes 110a-b is a two-terminal semiconductor light source. The plurality of light emitting diodes 110a-b is a p-n junction diode that emits light when activated.

In an embodiment of the present disclosure, the plurality of light emitting diodes 110a-b includes light emitting diodes of 5000 Kelvin. In an embodiment of the present disclosure, the plurality of light emitting diodes possesses a correlated color temperature of 5000 Kelvin. Moreover, number of the plurality of light emitting diodes 110a-b in the light emitting arrangement 106-108 are 224. In an embodiment of the present disclosure, the plurality of light emitting diodes 110a-b are arranged vertically on each of the printed circuit board 102-104. The plurality of light emitting diodes 110a-b in the light emitting arrangement 106-108 in the corresponding metal core printed circuit board 102-104 possess a thermal resistance having a value not more than 9 m²K/W.

Moreover, each of the light emission arrangement 106-108 includes a first pre-defined amount of sequential arrangements of the plurality of light emitting diodes 110a-b. In addition, each of the emission arrangement 106-108 includes a second pre-defined amount of lateral arrangements of the plurality of light emitting diodes 110a-b. In an embodiment of the present disclosure, the first pre-defined amount is sixteen. In another embodiment of the present disclosure, the second pre-defined amount is seven.

In an embodiment of the present disclosure, the printed circuit board 102 is internally linked to the printed circuit board 104 in the flood light structure 100. In another embodiment of the present disclosure, the printed circuit board 102 operates separately from the printed circuit board 104 in the flood light structure 100. Moreover, the flood light structure 100 optimizes junction temperature of the plurality of light emitting diodes 110a-b in a range of 65-70 degree Celsius. Moreover, the junction temperature is optimized to increase lumen maintenance of the plurality of light emitting diodes 110a-b (described in detailed description of FIG. 1B).

Going further, the flood light structure 100 includes an insulation layer 112. The insulation layer is longitudinally disposed over a surface of printed circuit board 102-104. In an embodiment of the present disclosure, the insulation layer 112 is spread on each of the metal core printed circuit board 102-104. Also, the insulation layer 112 provides protection to the printed circuit board 102-104. Further, the light emitting arrangement 106-108 is bonded to each of the metal core printed circuit board 102-104 via an insulation layer 112. In addition, thermal conductivity of the insulation layer 112 is in a range of 0.5-9 W/Mk. The insulation layer is a ceramic non-conductive layer.

In addition, the flood light structure 100 includes one or more power supplying devices attached to the flood light structure 100 through the printed circuit board 102-104. The one or more power supplying devices power up the light emission arrangement 106-108. The one or more power supplying devices supply an aggregate power of 400-450 W to the light emission arrangement 106-108. In an embodiment of the present disclosure, each printed circuit board 102-104 receives equal amount of power.

It may be noted that in FIG. 1A, the flood light structure 100 includes the printed circuit board 102-104; however, those skilled in the art would appreciate that the flood light structure 100 may include one or more metal core printed circuit board. It may also be noted that in FIG. 1A, the flood light structure 100 includes the light emitting arrangement 110a on the printed circuit board 102 and the light emitting arrangement 110b on the metal core printed circuit board 104; however those skilled in the art would appreciate that the flood light structure 100 may have more number of light emitting arrangements on the printed circuit board 102-104.

FIG. 1B illustrates an inner view of the flood light structure 100, in accordance with various embodiments of the present disclosure. It may be noted that to explain structural elements of FIG. 1B, references will be made to the structural elements of FIG. 1A. The flood light structure 100 includes the assembly of the physical supporting base. The physical supporting base includes the printed circuit board 102-104. Moreover, the printed circuit board 102-104 is positioned optimally in the flood light structure 100. The printed circuit board 102-104 includes a fixing arrangement 114. The fixing arrangement 114 includes a plurality of holes 116 which are fixed on each of the metal core printed circuit board 102-104. The plurality of holes 116 connects/fixes the light emission arrangement 106-108 on the corresponding printed circuit board 102-104.

In another embodiment of the present disclosure, the fixing arrangement 114 fixes the printed circuit board 102-104 in the flood light structure 100. The fixing arrangement 114 includes a plurality of bolts, a plurality of screws and a plurality of gaskets for fixing the light emission arrangement 106-108 on the corresponding printed circuit board 102-104. In addition, the fixing arrangement 114 includes a plurality of nuts and connectors for fixing the light emission arrangement 106-108 on the corresponding printed circuit board 102-104. In an embodiment of the present disclosure, the fixing arrangement 114 includes the plurality of bolts, the plurality of screws and the plurality of gaskets for fixing the printed circuit board 102-104 in the flood light structure 100. In another embodiment of the present disclosure, the fixing arrangement 114 includes the plurality of nuts and connectors for fixing the metal core printed circuit board 102-104 in the flood light structure 100.

Moreover, each of the light emission arrangement 106-108 includes a first pre-defined amount of sequential arrangements of the plurality of light emitting diodes 110a-b. In addition, each of the emission arrangement 106-108 includes a second pre-defined amount of lateral arrangements of the plurality of light emitting diodes 110a-b. In an embodiment of the present disclosure, the first pre-defined amount is sixteen. In another embodiment of the present disclosure, the second pre-defined amount is seven. In an embodiment of the present disclosure, the plurality of light emitting diodes 110a-b are arranged perpendicularly to a longitudinal axis of the printed circuit board 102-104. Further, the printed circuit board 102-104 includes a metallic substrate wired with one or more tinned copper tracks. The metallic substrate is made of aluminium.

Further, the light emitting arrangement 106-108 of the flood light structure 100 is bonded with the each of the metal core printed circuit board 102-104 via the corresponding insulation layer 112. In addition, the flood light structure 100 includes one or more power supplying sources. In an embodiment of the present disclosure, the one or more power supplying sources refer to the one or more power supplying devices (illustrated in detailed description of FIG. 1A).

The one or more power supplying sources is electrically coupled to the light emission arrangement 106-108. The one or more power supplying sources supplies the aggregate power of 400-450 W to the light emission arrangement 106-108. In an embodiment of the present disclosure, the input power needed by the flood light structure 100 is in a range of 380-385 Watts. In an embodiment of the present disclosure, voltage needed by the one or more power supplying sources is in a range of 27-54 Volts. In an embodiment of the present disclosure, current passing through the flood light structure 100 is in a range of 3-4 Volts.

The flood light structure 100 utilizes the printed circuit board 102-104 to reduce the junction temperature. The thermal conductivity of the printed circuit board 102-104 is up to 3 W/Mk (as explained above). In addition, the flood light structure 100 lowers the junction temperature of the plurality of light emitting diodes 110a-b by utilization of one or more parameters of the plurality of light emitting diodes 110a-b. The one or more parameters include density and thermal resistance. In addition, the density of the plurality of light emitting diodes 110a-b is in the range of 2.17-2.2 pieces per square centimeters. The value of the thermal resistance of the plurality of light emitting diodes 110a-b is not more than 9 m²K/W. In an embodiment of the present disclosure, the optimized value of the junction temperature is in the range of 65-70 degree Celsius. The optimized value of the junction temperature increases lumen maintenance and durability of the plurality of light emitting diodes 110a-b.

Further, the insulation layer 112 is greased with a thermal paste to transfer dissipated heat to a heat sink. In an embodiment of the present disclosure, amount of thermal paste used is 0.05 Kilograms.

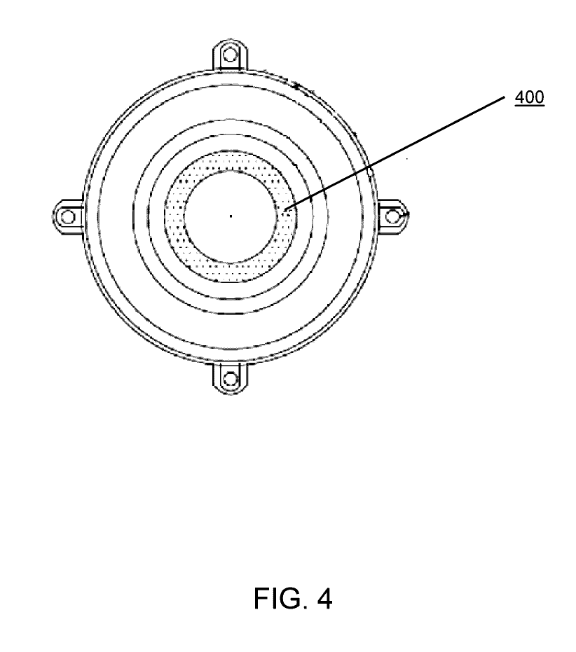

In addition, the flood light structure 100 includes one or more reflectors disposed on the printed circuit board 102-104 (as illustrated in detail description of FIG. 4). Each of the one or more reflectors is configured to reflect light emitting from each of the plurality of light emitting diodes 110a-b. In an embodiment of the present disclosure, the one or more reflectors include a top reflector and a bottom reflector. Each of the light emitting arrangement 106-108 includes the top reflector and the bottom reflector. In an embodiment of the present disclosure, the one or more reflectors are made of a mixture of 60 percent of polycarbonate and 40 percent of acrylonitirile-butadiene-styrenel.

Further, the flood light structure 100 includes a transparent cover 120. The transparent cover 120 is a top cover. The transparent cover 120 encloses the flood light structure 100. In addition, a plurality of illuminating heads of each of the plurality of light emitting diodes 110a-b face towards the transparent cover 120 in a vertical direction. Moreover, the top cover 120 is made from an aluminium di-casting alloy. The aluminium di-casting alloy is an alloy made from di-casting of the aluminium metal. The di-casting is a process that forces a molten metal (herein ‘aluminium’) into a mold cavity by application of high pressure.

In an embodiment of the present disclosure, the flood light structure 100 includes a plurality of washers. The plurality of washers includes one or more plain washers and one or more spring washers. The plurality of washers creates a bright flood of colorful lights and makes the plurality of light emitting diodes 110a-b water resistant.

In addition, input voltage applied to the flood light structure 100 is in a range of 90-305 Volts. The plurality of light emitting diodes 110a-b will glow when the input voltage is near to threshold value of the plurality of light emitting diodes 110a-b. In an embodiment of the present disclosure, the threshold of the plurality of light emitting diodes 110a-b is less than 10 percent. Also, the correlated cooler temperature of the plurality of light emitting diodes 110a-b is 5000 Kelvin.

The forward voltage of the plurality of light emitting diodes 110a-b is 2.9-3.2 Volts. The forward voltage is a voltage drop across each of the plurality of light emitting diodes 110a-b if voltage at anode is more positive than voltage at cathode. The forward current of the plurality of light emitting diodes 110a-b is 0.492 Ampere. The forward current is a current which flows across each of the plurality of light emitting diodes 110a-b from the anode to the cathode. The forward current flows from the anode to the cathode so that each of the plurality of light emitting diodes 110a-b receives a sufficient current to operate and function.

It may be noted that in FIG. 1B, the fixing arrangement 114 is utilized to connect/fix the light emission arrangement 106-108 on each of the printed circuit board 102-104; however, those skilled in the art would appreciate that there may be more fixing arrangements that can be utilized to connect/fix the light emitting arrangement 106-108 on each of the printed circuit board 102-104.

It may be noted that in FIG. 1B, the fixing arrangement 114 is utilized to fix each of the printed circuit board 102-104 in the flood light structure 100; however those skilled in the art would appreciate that there may be more fixing arrangements that can be utilized to fix each of the printed circuit board 102-104 in the flood light structure 100.

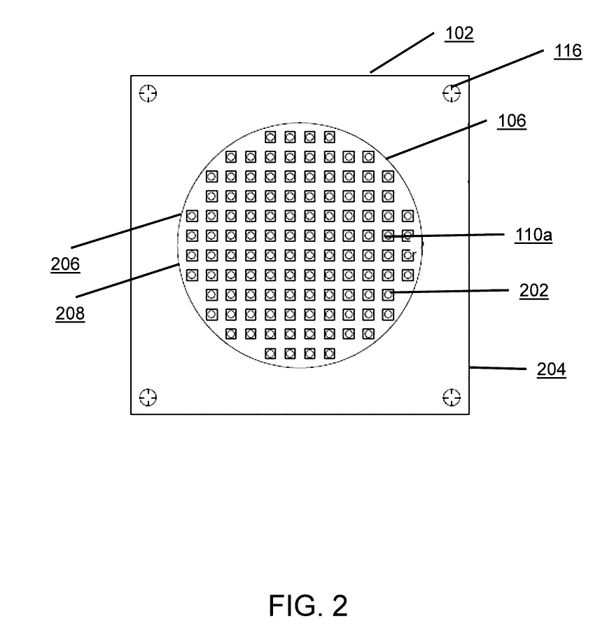

FIG. 2 illustrates the printed circuit board 102 with the metal core, in accordance with various embodiments of the present disclosure. It may be noted that to explain the structural elements of FIG. 2, references will be made to the structural elements of FIG. 1A and FIG. 1B.

The printed circuit board 102 resides in the flood light structure 100. The printed circuit board 102 includes the lighting emission arrangement 106. Further, the printed circuit board 102 includes the fixing arrangement 114. The plurality of holes 116 of the fixing arrangement 114 fixes the light emission arrangement 106 on the printed circuit board 102. Furthermore, the printed circuit board 102 includes the metallic substrate 118 (as illustrated in the detailed description of FIG. 1A and FIG. 1B). The lighting emission arrangement 106 is bonded to the printed circuit board 102 via the insulation layer 112 (as described in detailed description of FIG. 1A and FIG. 1B). Furthermore, the lighting emission arrangement 106 includes the plurality light emitting diodes 110a. In an embodiment of the present disclosure, the plurality of light emitting diodes 110a is arranged vertically on the printed circuit board 102.

In addition, a plurality of illuminating heads 202 of each of the plurality of light emitting diodes 110a-b face towards the transparent cover 120 in a vertical direction. Furthermore, a power feeding arrangement 204 of the one or more power supplying sources supplies a power of 200 Watts to the plurality of light emitting diodes 110a of the lighting emitting arrangement 106. The power feeding arrangement 204 is electrically coupled to the light emitting arrangement 106. In addition, the light emission arrangement 106 includes the first pre-defined amount of sequential arrangements of the plurality of light emitting diodes 110a. In addition, the light emission arrangement 106 includes the second pre-defined amount of lateral arrangements of the plurality of light emitting diodes 110a. Further, the first pre-defined amount is sixteen. Furthermore, the second pre-determined amount is seven. In addition, a top reflector 206 and a bottom reflector 208 of the one or more reflectors reflect the light emitting from each of the plurality of light emitting diodes 110a (as illustrated in detail description of FIG. 4).

It may be noted that in FIG. 2, the plurality of illuminating heads 202, the power feeding arrangement 204, the top reflector 206 and the bottom reflector 208 are described corresponding to the printed circuit board 102; however, those skilled in the art would appreciate that a plurality of illuminating heads, a power generating arrangement, a top reflector and a bottom reflector can be described corresponding to the printed circuit board 104.

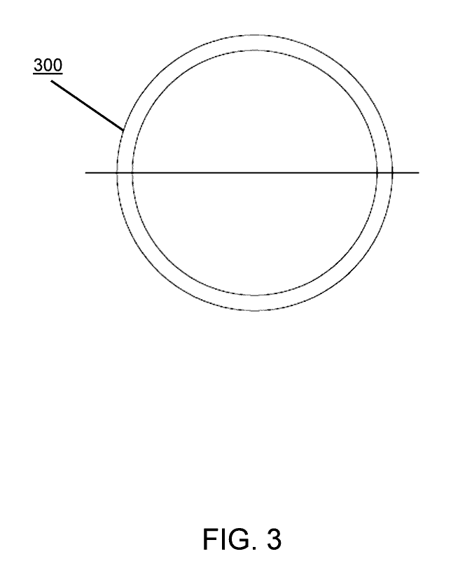

FIG. 3 illustrates a structural element of the flood light structure 100, in accordance with various embodiments of the present disclosure. It may be noted that to explain the structural elements of FIG. 3, references will be made to the structural elements of FIG. 1A, FIG. 1B and FIG. 2. The FIG. 3 illustrates a glass 300. The glass 300 encloses each of the printed circuit board 102-104. The glass 300 is a borosilicate glass. The borosilicate glass is has silica and boron trioxide as main constituents. The borosilicate glass has low coefficient of thermal expansion that makes the glass 300 resistant to thermal shock and thermal stress. In an embodiment of the present disclosure, the glass 300 has a coefficient of thermal expansion in a range of ˜3×10⁻⁶/C at 20 degree Celsius. The low coefficient of thermal expansion of the glass 300 increases the lumen maintenance of the plurality of light emitting diodes 110a-b.

In an embodiment of the present disclosure, diameter of the glass 300 is in a range of 5 millimeters to 5.5 millimeters. The glass 300 is positioned on top of each of the light emission arrangement 106-108. Moreover, the glass 300 is fixed into the transparent cover 120 of the printed circuit board 102-104. In an embodiment of the present disclosure, the glass 300 can withstand rapid temperature variations. Moreover, when subjected to uneven temperature variations, the glass 300 tends to crack into larger pieces rather than shattering.

FIG. 4 illustrates a reflector 400, in accordance with various embodiments of the present disclosure. It may be noted that to explain the structural elements of FIG. 4, references will be made to the structural elements of FIG. 1A, FIG. 1B, FIG. 2 and FIG. 3. In an embodiment of the present disclosure, the reflector 400 may be the top reflector 206 and/or the bottom reflector 208. The reflector 400 surrounds each of the light emission arrangement 106-108. The reflector 400 reflects the light emitting from each of the plurality of light emitting diodes 110a-b.

The reflector 400 is made of the mixture of 60 percent of the polycarbonate and 40 percent of the acrylonitirile-butadiene-styrenel. Due to this material, the reflector 400 provides resilience even at low temperatures. Further, the reflector 400 has improved impact resistance, toughness, and heat resistance. In an embodiment of the present disclosure, the reflector 400 may be mounted to the flood light structure 100. In another embodiment of the present disclosure, the reflector 400 may be mounted to a heat collector. In yet another embodiment of the present disclosure, the reflector 400 may be glued to the printed circuit board 102-104. In yet another embodiment of the present disclosure, the reflector 400 may be glued on an additional bayonet on module.

It may be noted that in FIG. 4, the reflector 400 surrounds each of the light emission arrangement 106-108; however, those skilled in the art would appreciate that the reflector 400 may surround the flood light structure 100.

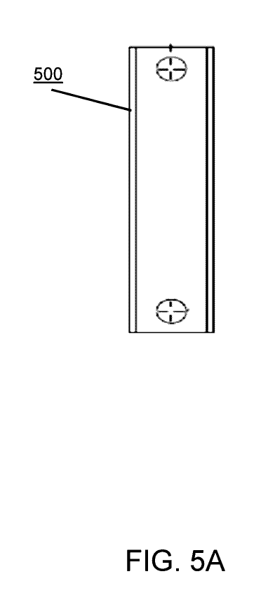

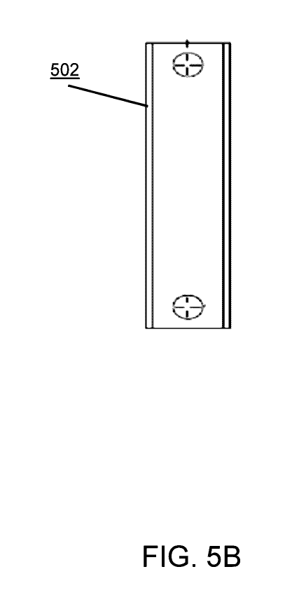

FIG. 5A illustrates a first clamp 500, in accordance with various embodiments of the present disclosure. It may be noted that to explain the structural elements of FIG. 5A, references will be made to the structural elements of FIG. 1A, FIG. 1B, FIG. 2, FIG. 3 and FIG. 4. The first clamp 500 is a U-shaped clamp. The first clamp 500 is connected to the light emission arrangement 106. In an embodiment of the present disclosure, the first clamp 500 is made of zinc coated steel.

It may be noted that in FIG. 5A, the first clamp 500 is the U-shaped clamp; however, those skilled in the art would appreciate that the first clamp 500 may have any other shape known in the art which could connect the first clamp 500 easily to the light emitting arrangement 106.

It may also be noted that in FIG. 5A, the first clamp 500 is connected to the light emission arrangement 106; however, those skilled in the art would appreciate that one or more clamps may be connected to the light emission arrangement 106.

FIG. 5B illustrates a second clamp 502, in accordance with various embodiments of the present disclosure. It may be noted that to explain the structural elements of FIG. 5B, references will be made to the structural elements of FIG. 1A, FIG. 1B, FIG. 2, FIG. 3, FIG. 4 and FIG. 5A. The second clamp 502 is the U-shaped clamp. The second clamp 502 is connected to the light emission arrangement 108. In an embodiment of the present disclosure, the second clamp 502 is made of zinc coated steel.

It may be noted that in FIG. 5B, the second clamp 502 is the U-shaped clamp; however, those skilled in the art would appreciate that the second clamp 502 may have any other shape known in the art which could connect the first clamp 500 easily to the light emission arrangement 108.

It may also be noted that in FIG. 5B, the second clamp 502 is connected to the light emission arrangement 108; however, those skilled in the art would appreciate that the one or more clamps may be connected to the light emission arrangement 108.

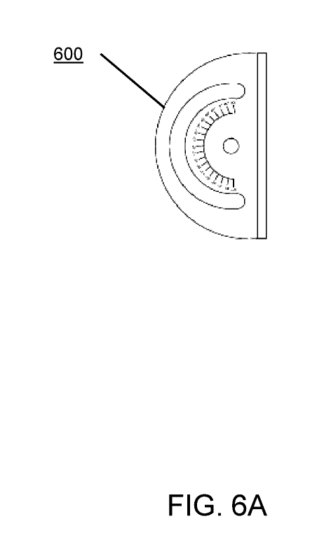

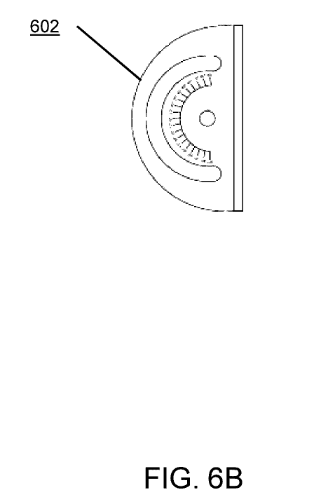

FIG. 6A illustrates a third clamp 600, in accordance with various embodiments of the present disclosure. It may be noted that to explain the structural elements of FIG. 6A, references will be made to the structural elements of FIG. 1A, FIG. 1B, FIG. 2, FIG. 3, FIG. 4, FIG. 5A and FIG. 5B. The third clamp 600 is an angle clamp. The third clamp 600 is connected to the light emission arrangement 106. In an embodiment of the present disclosure, the third clamp 600 is made of zinc coated steel.

It may be noted that in FIG. 6A, the third clamp 600 is connected to the light emission arrangement 106; however, those skilled in the art would appreciate that one or more angle clamps may be connected to the light emission arrangement 106.

FIG. 6B illustrates a fourth clamp 602, in accordance with various embodiments of the present disclosure. It may be noted that to explain the structural elements of FIG. 6B, references will be made to the structural elements of FIG. 1A, FIG. 1B, FIG. 2, FIG. 3, FIG. 4, FIG. 5A, FIG. 5B and FIG. 6A. The fourth clamp 602 is the angle clamp. The fourth clamp 602 is connected to the light emission arrangement 108. In an embodiment of the present disclosure, the fourth clamp 602 is made of zinc coated steel.

It may be noted that in FIG. 6B, the fourth clamp 602 is connected to the light emission arrangement 108; however, those skilled in the art would appreciate that the one or more angle clamps may be connected to the light emission arrangement 108.

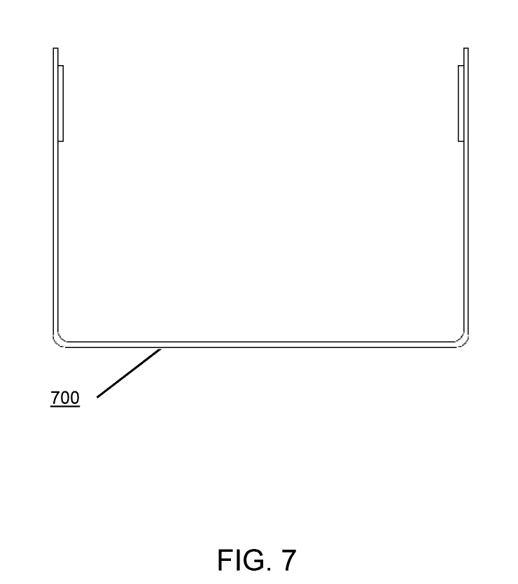

FIG. 7 illustrates a holding bracket 700, in accordance with various embodiments of the present disclosure. It may be noted that to explain the structural elements of FIG. 7, references will be made to the structural elements of FIG. 1A, FIG. 1B, FIG. 2, FIG. 3, FIG. 4, FIG. 5A, FIG. 5B, FIG. 6A and FIG. 6B. The holding bracket 700 holds the flood light structure 100. In an embodiment of the present disclosure, the holding bracket 700 is made of zinc coated steel. In an embodiment of the present disclosure, the holding bracket 700 is a U-shaped bracket utilized for providing support to the flood light structure 100.

It may be noted that in FIG. 7, the holding bracket 700 is the U-shaped bracket; however those skilled in the art would appreciate that the holding bracket 700 may have any other shape known in the art which could be utilized for providing support to the flood light structure 100.

The flood light structure 100 has several advantages. The flood light structure 100 possesses significant lumen maintenance even on increased packing density of the plurality of light emitting diodes 110a-b. Further, the flood light structure 100 possesses a longer durability. In addition, the flood light structure 100 has a more compact design. Moreover, the flood light structure 100 reduces the junction temperature of the plurality of light emitting diodes 110a-b even on increasing the compactness and the packing density of the plurality of light emitting diodes 110a-b. Further, the flood light structure 100 requires the reduced forward voltage and the forward current. Furthermore, the flood light structure 100 possesses enhanced thermal management.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A flood light structure for one or more flood lights, the flood light structure being powder coated, the flood light structure comprising:
an assembly of a physical supporting base being positioned in the flood light structure, the assembly being constructed with a plurality of substances, wherein the physical supporting base comprises one or more printed circuit board having a metal core, wherein the one or more printed circuit board being mounted parallel to each other and wherein a thermal conductivity associated with each of the one or more printed circuit board being in a range of 0.5-3 W/Mk;
an insulation layer, the insulation layer being longitudinally disposed over a surface of each of the one or more printed circuit board, wherein the insulation layer provides protection to each of the one or more printed circuit board, wherein a thermal conductivity of the insulation layer being in a range of 0.5-9 W/Mk and wherein the insulation layer being a ceramic non-conductive layer; and
one or more light emission arrangements being securely mounted on surface of each of the one or more printed circuit board through the insulation layer, wherein each of the one or more light emission arrangements comprises a plurality of light emitting diodes, wherein each of the one or more light emission arrangements being configured to emit light in a uniform direction substantially parallel to the one or more printed circuit board, wherein the plurality of light emitting diodes being connected to the corresponding one or more printed circuit board through a plurality of holes, wherein each of the plurality of light emitting diodes having density in a range of 2.17-2.2 pieces per square centimeters, and wherein each of the plurality of light emitting diodes possess a thermal resistance in a pre-determined range of 4.0-6.0 m²K/W,
wherein an increased lumen maintenance of the plurality of light emitting diodes being achieved by optimization of a junction temperature associated with the plurality of light emitting diodes in a pre-determined range of 65-70 degree Celsius.

2. The flood light structure as recited in claim 1, wherein a printed circuit board of the one or more printed circuit board being internally linked to another printed circuit board of the one or more printed circuit board in the flood light structure.

3. The flood light structure as recited in claim 1, wherein the printed circuit board of the one or more printed circuit board operates separately from the another printed circuit board of the one or more printed circuit board in the flood light structure.

4. The flood light structure as recited in claim 1, further comprising one or more power supplying devices attached to the flood light structure through the one or more printed circuit board, the one or more power supplying devices being configured for powering up the one or more light emission arrangements by supplying an aggregate power of 400-450 W and wherein each of the one or more printed circuit board receives equal amount of power.

5. The flood light structure as recited in claim 1, wherein the plurality of substances for the construction of the one or more printed circuit board comprises at least one of an aluminium substrate, one or more tinned copper tracks and white mask.

6. The flood light structure as recited in claim 1, wherein each of the one or more light emission arrangements comprises a first pre-defined amount of sequential arrangements of the plurality of light emitting diodes and a second pre-defined amount of lateral arrangements of the plurality of light emitting diodes, wherein the first pre-defined amount being sixteen and wherein the second pre-defined amount being seven and wherein the plurality of light emitting diodes possesses a correlated color temperature of 5000 Kelvin.

7. The flood light structure as recited in claim 1, wherein the insulation layer being greased with a thermal paste to transfer dissipated heat to a heat sink.

8. The flood light structure as recited in claim 1, wherein each of the plurality of light emitting diodes being arranged longitudinally on each of the one or more printed circuit board.

9. A flood light structure for one or more flood lights, the flood light structure being powder coated, the flood light structure comprising:
an assembly of a physical supporting base being positioned optimally in the flood light structure, wherein the physical supporting base comprises one or more printed circuit board having a metal core, wherein the one or more printed circuit board being mounted parallel to each other, wherein a thermal conductivity associated with each of the one or more printed circuit board being in a range of 0.5-3 W/Mk, wherein each of the one or more printed circuit board comprises:
a fixing arrangement comprising a plurality of holes, wherein the plurality of holes being fixed on each of the one or more printed circuit board; wherein each of the plurality of holes being placed along a boundary of the flood light structure and corners of the one or more printed circuit board and
a metallic substrate wired with one or more tinned copper tracks, wherein the metallic substrate being made of aluminium;
an insulation layer, the insulation layer being longitudinally placed over a length on each of the one or more printed circuit board, wherein the insulation layer provides protection to each of the one or more printed circuit board, wherein a thermal conductivity of the insulation layer being in a range of 0.5-9 W/Mk and wherein the insulation layer being a ceramic non-conductive layer;
one or more light emitting sources connected to the corresponding one or more printed circuit board through the plurality of holes, wherein each of the one or more light emitting sources comprises a plurality of light emitting diodes, wherein each of the one or more light emitting sources being longitudinally placed apart from each other, wherein each of the one or more light emitting diodes being bonded with the metallic substrate via the insulation layer, wherein each of the plurality of light emitting diodes having density in a range of 2.17-2.2 pieces per square centimeters and wherein each of the plurality of light emitting diodes possess a thermal resistance in a pre-determined range of 4.0-6.0 m²K/W; and
one or more power supplying sources electrically coupled to each of the one or more light emitting sources, the one or more power supplying sources being configured for powering up the one or more light emitting sources by supplying an aggregate power of 400-450 W and wherein each of the one or more light emitting sources receives equal amount of power,
wherein an increased lumen maintenance of the plurality of light emitting diodes being achieved by optimization of a junction temperature associated with the plurality of light emitting diodes in a range of 65-70 degree Celsius.

10. The flood light structure as recited in claim 9, wherein each of the one or more light emitting sources comprises a first pre-defined amount of sequential arrangements of the plurality of light emitting diodes and a second pre-defined amount of lateral arrangements of the plurality of light emitting diodes, wherein the first pre-defined amount being sixteen and wherein the second pre-defined amount being seven and wherein the plurality of light emitting diodes possesses a correlated color temperature of 5000 Kelvin.

11. The flood light casing as recited in claim 9, wherein the insulation layer being greased with a thermal paste to transfer dissipated heat to a heat sink.

12. The flood light casing as recited in claim 9, wherein each of the plurality of light emitting diodes protrude in a vertical direction on each of the one or more printed circuit board.

13. The flood light casing as recited in claim 9, wherein a printed circuit board of the one or more printed circuit board being internally linked to another printed circuit board of the one or more printed circuit board in the flood light structure.

14. The flood light casing as recited in claim 9, wherein the printed circuit board of the one or more printed circuit board operates separately from the another printed circuit board of the one or more printed circuit board in the flood light structure and wherein the flood light structure possesses a correlated color temperature of 5000 Kelvin.

15. A flood light structure for one or more flood lights, the flood light structure being powder coated, the flood light structure comprising:
an assembly of a physical supporting base being positioned optimally in the flood light structure, wherein the physical supporting base comprises one or more printed circuit board having a metal core, wherein the one or more printed circuit board being mounted parallel to each other, wherein a thermal conductivity associated with each of the one or more printed circuit board being in a range of 0.5-3 W/Mk, wherein each of the one or more printed circuit board comprises:
a fixing arrangement comprising a plurality of holes, wherein the plurality of holes being fixed on each of the one or more printed circuit board; wherein each of the plurality of holes being placed along a boundary of the flood light structure and corners of the one or more printed circuit board and
a metallic substrate wired with one or more tinned copper tracks, wherein the metallic substrate being made of aluminium;
an insulation layer, the insulation layer being longitudinally placed over a length on each of the one or more printed circuit board, wherein the insulation layer provides protection to each of the one or more printed circuit board, wherein a thermal conductivity of the insulation layer being in a range of 0.5-9 W/Mk and wherein the insulation layer being a ceramic non-conductive layer;
one or more light emitting apparatus connected to the corresponding one or more printed circuit board through the plurality of holes, wherein each of the one or more light emitting apparatus comprises a plurality of light emitting diodes, wherein each of the one or more light emitting apparatus being longitudinally placed apart from each other, wherein each of the one or more light emitting diodes being bonded with the metallic substrate via the insulation layer, wherein each of the plurality of light emitting diodes having density in a range of 2.17-2.2 pieces per square centimeters and wherein each of the plurality of light emitting diodes possess a thermal resistance in a pre-determined range of 4.0-6.0 m²K/W; and
a transparent cover, wherein the transparent cover encloses the flood light structure and wherein a plurality of illuminating heads of each of the plurality of light emitting diodes face towards the transparent cover in a vertical direction; and
one or more power feeding arrangements configured for powering up the one or more light emitting apparatus by supplying an aggregate power of 400-450 W and wherein each of the one or more light emitting apparatus receives equal amount of power,
wherein an increased lumen maintenance of the plurality of light emitting diodes being achieved by optimization of a junction temperature associated with the plurality of light emitting diodes in a range of 65-70 degree Celsius.

16. The flood light structure as recited in claim 15, wherein each of the one or more light emitting apparatus comprises a first pre-defined amount of sequential arrangements of the plurality of light emitting diodes and a second pre-defined amount of lateral arrangements of the plurality of light emitting diodes, wherein the first pre-determined amount being sixteen and wherein the second pre-determined amount being seven and wherein the plurality of light emitting diodes possesses a correlated color temperature of 5000 Kelvin.

17. The flood light structure as recited in claim 15, wherein the insulation layer being greased with a thermal paste to transfer dissipated heat to a heat sink.

18. The flood light structure as recited in claim 15, wherein each of the plurality of light emitting diodes protrude in a vertical direction on each of the one or more printed circuit board and wherein the flood light structure possesses a correlated color temperature of 5000 Kelvin.

19. The flood light structure as recited in claim 15, wherein the transparent cover being made of aluminium di-casting alloys.

20. The flood light casing as recited in claim 15, further comprising one or more reflectors disposed on the one or more printed circuit board, wherein each of the one or more reflectors being configured to reflect light emitting from each of the plurality of light emitting diodes and wherein the one or more reflectors comprises a top reflector and a bottom reflector.
